(19) United States
(12) Patent Application Publication
(10) Pub. No.: US 2011/0079125 A1
(43) Pub. Date: Apr. 7, 2011

(54) Circular Saw

(76) Inventor: Hsin-Cheng Kuo, Taipei City (TW)

(21) Appl. No.: 12/571,512

(22) Filed: Oct. 1, 2009

(51) Int. Cl. B26D 7/18; B26D 1/14

(52) U.S. Cl. 83/168; 83/471

(57) ABSTRACT

A circular saw is composed of a working platform, a saw base with saw plate, and a saw cover, wherein the saw base and the saw cover are combined together to perform a dust-collecting hood with a bottom opening to accommodate the saw plate. The dust-collecting hood has a first air-hole defined on a top and a second air-hole defined on a sidewall respectively to completely keep the swarf and dust inside the dust-collecting hood to sufficiently improve the dust-collecting efficiency. Moreover, the saw base and the saw cover have an enclosed sheet respectively to make the bottom opening narrowed to only allow the saw plate passing therethrough to further significantly improve the dust-collecting efficiency, to achieve highly efficiency for collecting swarf and dust, and to keep working environment clean.

### BACKGROUND OF THE INVENTION

1. Field of the Invention

The present invention relates to a circular saw, and more particularly to a circular saw device which has sufficient cleaning efficiency and is safe and convenient in use.

2. Description of Related Art

Conventional circular saws are used to cut woods or other constructing materials and thus generate swarf and dust inevitably during operation. Therefore, a market-available conventional circular saw is equipped with a dust-collecting structure to collect the swarf and dust. As shown in FIG. 1 which shows the dust-collecting structure of the conventional circular saw, the circular saw 1 comprises a body 10 and a working platform 12 attached under the body 10 and a dust-collecting hood 14 surrounding the body 10. After positioning a workpiece on the working platform 12 (for example: wood or other similar constructing material), the saw plate 16 inside the body 10 is driven by a motor (not shown) to rotate counterclockwise to cut the workpiece in operation.

The swarf and dust generated during operation are blown to fly along with the airflow shown as Arrow A occurred by rotation of saw plate 16.

However, the above-mention dust-collecting structure cannot efficiently collect the swarf and dust with quiet little specific gravity. Moreover, the swarf and dust flows along with the airflow are usually emitted out of the dust-collecting hood 14 via an opening for the saw plate 16 extending out of the hood 14. Thus, the dust-collecting efficiency is corresponding deteriorated. The swarf and dust not only pollute the working environment but also likely damage the trachea of workers if the workers inevitably inhale swarf and dust during operation.

### SUMMARY OF THE INVENTION

A main objective of the present invention is to provide a circular saw that has excellent dust-collecting efficiency and is safe and convenient in use.

To achieve the foregoing objective, the circular saw comprises:

a working platform;

a saw base with a saw plate pivotally mounted on the working platform;

a saw cover pivotally attached to the saw base to perform a dust-collecting hood with a bottom opening to accommodate the saw plate, wherein the saw plate partially emerges out of the bottom opening and is driven by a motor;

a first air-hole defined on a top of the dust-collecting hood over the bottom opening;

a second air-hole defined on a sidewall of the dust-collecting hood facing the saw plate;

one enclosed sheet formed on the saw base and another enclosed sheets formed on the saw cover correspondingly to narrow the bottom opening to only allow passing the saw plate.

Further benefits and advantages of the present invention will become apparent after a careful reading of the detailed description with appropriate reference to the accompanying drawings.

### BRIEF DESCRIPTION OF THE DRAWINGS

FIG. 1 is a partially cross-sectional side view of a conventional circular saw with a dust-collecting hood in accordance with the prior art;

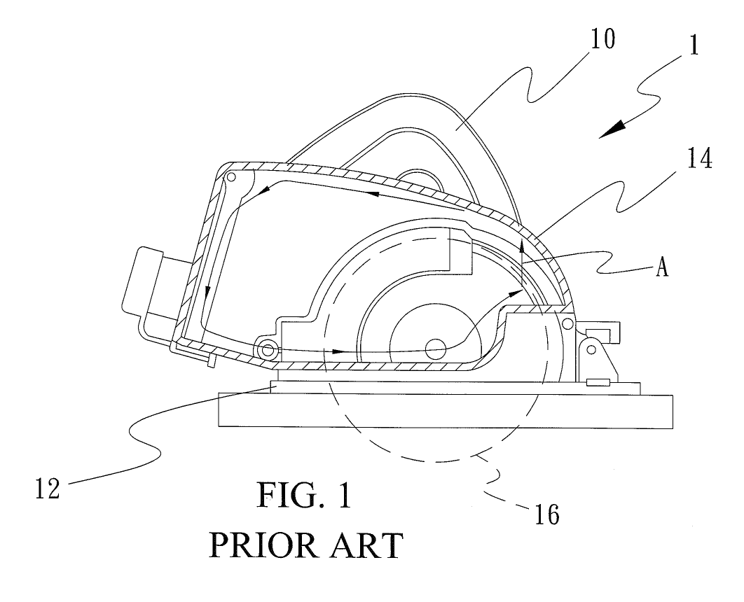

FIG. 2 is a perspective view of a circular saw in accordance with the present invention;

FIG. 3 is a partially exploded perspective view of the circular saw in FIG. 1;

FIG. 4 is an operational perspective view of the circular saw in accordance with the present invention; and

FIG. 5 is a partially exploded perspective view of one embodiment of the circular saw in accordance with the present invention.

### DETAILED DESCRIPTION OF THE PREFERRED EMBODIMENT

A circular saw in accordance with the present invention is substantially composed of a working platform, a saw base with saw plate, and a saw cover, wherein the saw base and the saw cover are combined together to perform a dust-collecting hood with a bottom opening to accommodate the saw plate. The dust-collecting hood has a first air-hole defined on a top and a second air-hole defined on a sidewall respectively to completely keep the swarf and dust inside the dust-collecting hood to sufficiently improve the dust-collecting efficiency. Moreover, the saw base and the saw cover have an enclosed sheet respectively to make the bottom opening narrowed to only allow the saw plate passing therethrough to further significantly improve the dust-collecting efficiency, to achieve highly efficiency for collecting swarf and dust, and to keep working environment clean.

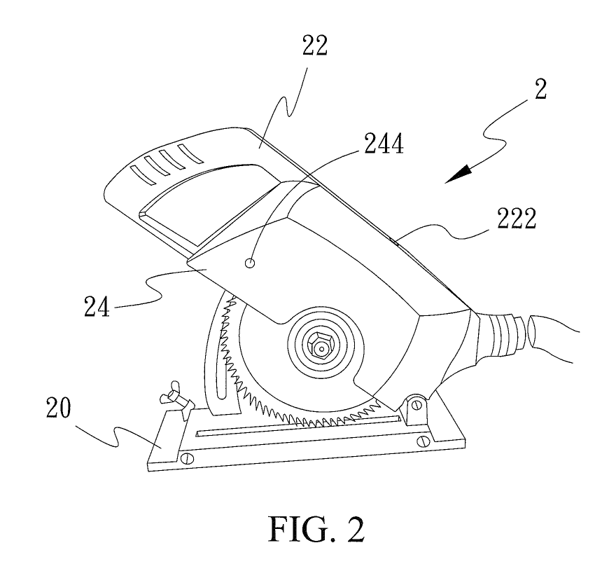

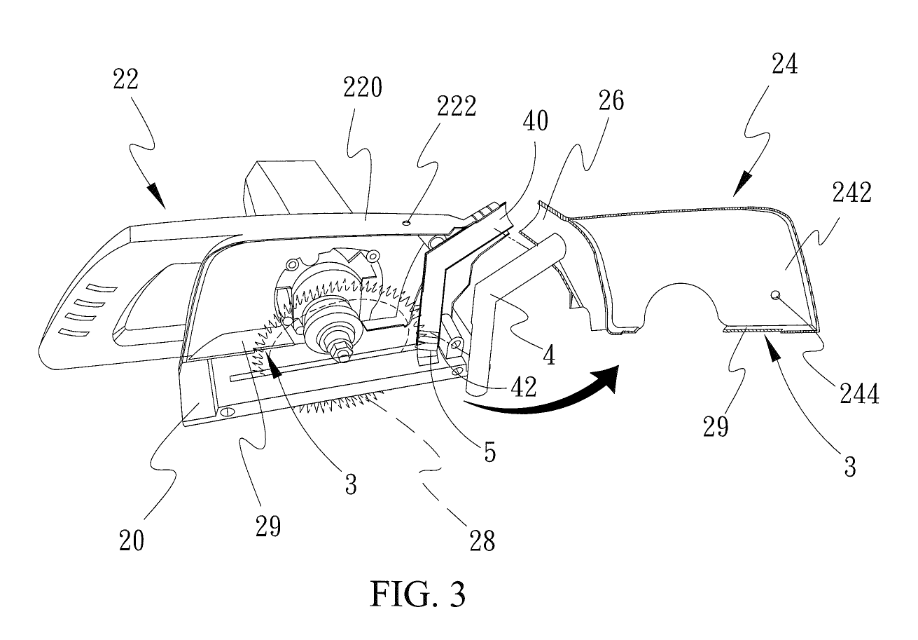

A preferred embodiment of the circular saw is shown in FIGS. 2 and 3 that illustrate the circular saw and the dust-collecting in perspective and partially exploded cross-sectional views. The circular saw 2 in this preferred embodiment comprises a working platform 20, a saw base 22 with a saw plate 28 and saw cover 24. The saw base 22 is pivotally mounted at one end of the working platform 20 and the saw cover 24 having same edge periphery with the saw base is pivotally attached to the saw base 22 to perform a dust-collecting hood with a bottom opening 3. Moreover a channel 26 is defined near a pivotal joint of the saw base 22 and the saw cover 24 inside the dust-collecting hood. The saw plate 28 is mounted on the saw base 22, driven by a motor (not shown), and partially emerges out of the dust-collecting hood via the bottom opening 3. Wherein, at least one first air-hole is defined on a top of the dust-collecting hood, specifically one first air-hole 222 defined on a top edge 220 of the saw base 22, correspondingly over the bottom opening 3. Furthermore, at least one second air-hole 244 (only one second air-hole 244 is shown in figures) is defined on a sidewall 242 of the saw cover 24 facing the saw plate 28 and cooperates with the first air-hole 222 to generate airflows. The saw base 22 and the saw cover 24 have an enclosed sheet 29 respectively to make the bottom opening 3 narrowed to only allow the saw plate 28 passing therethrough to improve airflow convection.

Additionally, a subsidiary hood 4 with an outlet 40 and an inlet 42 covers two sides of the saw plate 28 at the channel 26. Another sealing 5 is mounted to fill the gap between the subsidiary cover 4 and the working plate 20.

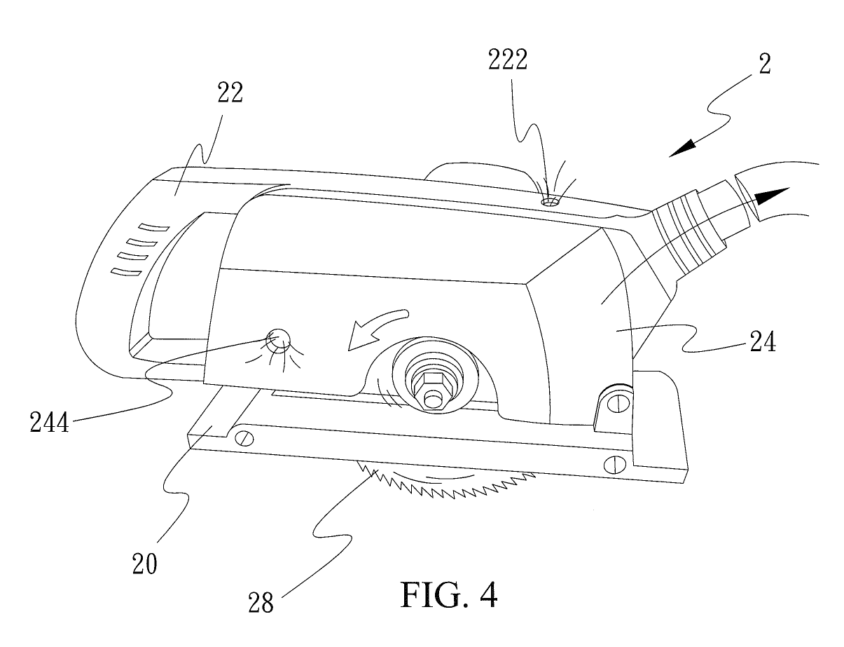

As shown in FIG. 4 which is a schematic drawing showing the airflow when the saw plate 28 rotates, the air-holes 222, 224 have airflows correspondingly shown herein. As shown in FIG. 3, when the circular saw 2 actuates, the saw plate 28 driven by the motor shears air and thus generates airflows. Meanwhile, the swarf and dust occurred by cutting the wood or other similar constructing structure are blown to spread out. By constructing the channel 26 integrally formed inside the dust-collecting hood, and the airflow-trimming design (air-holes), the circular saw 2 enables to sufficiently collect the swarf and dust to avoid spreading out of the dust-collecting hood.

Additionally, by defining the first air-hole 222 on the top 220 at the bottom opening 3 and the second air-hole 244 on the sidewall 242 facing the saw plate 28 on the dust-collecting hood, a negative pressure status is incurred by introducing air into the dust-collecting hood through the channel 26 when saw plate 28 rotates. Therefore, the dwarf and the dust cannot flow out of dust-collecting hood. By defining the first air-hole 222 and second air-hole 244, the negative pressure problem is resolved and the pressure balance is achieved.

Except the above-mentioned channel 26, by performing the first air-hole 222 on the saw base 22, a better airflow-trimming efficiency is achieved and also a dust-containing airflow and a clean airflow are separated. Thus, the circular saw 2 in the present invention not only improves the flow path of airflow but also discharge surplus dust in small quantity via the channel 26 by pressurizing efficiency of the first air-hole 222.

Moreover, by having the enclosed sheet 29 on the saw base 22 and the saw cover 24 respectively, the convection efficiency of airflow is increased and the bottom opening 3 is narrowed to only allow the saw plate 28 passing therethrough so that the swarf and dust generated by operation of the circular saw 2 are completely retained between the saw base 22 and the saw cover 24 to sufficiently improve the dust-collecting efficiency.

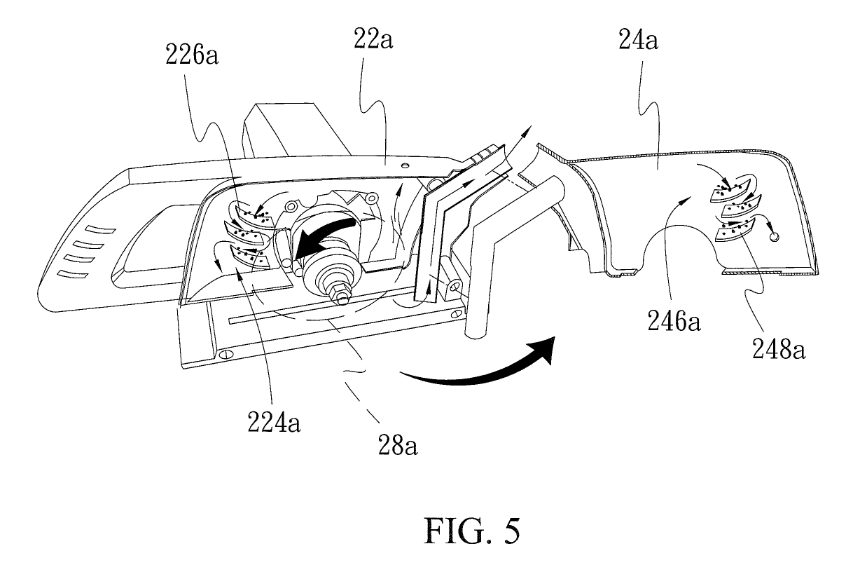

As shown in FIG. 5, another preferred embodiment of the circular saw in accordance with the present invention is illustrated schematically, wherein the circular saw has the air-holes and multiple retarding sheets inside the dust-collecting hood to retard the discharge of airflow and to increase the dust-collecting efficiency. According to this figure, the saw base 22a has an interior sidewall 224a facing the saw plate 28a and multiple first retarding sheets 226a formed on the interior sidewall 224a to detour the discharge of the airflow and to completely block and retain the dwarf and dust inside the dust collecting hood before the airflow is discharged. Correspondingly, the saw cover 24a has an interior sidewall 246a facing the saw plate 28a and multiple second retarding sheets 248a formed on the interior sidewall 246a to detour the discharge of the airflow and to completely block and retain the dwarf and dust inside the dust collecting hood before the airflow is discharged. Thereby, when airflow flow between the saw base 22a and saw cover 24a, the airflow is disturbed by the first retarding sheets 226a and the second retarding sheets 248a for a long duration and the swarf and dust are mostly kept on the first and second retarding sheets 226a, 248a.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A circular saw comprising:
a working platform;
a saw base with a saw plate pivotally mounted on the working platform;
a saw cover pivotally attached to the saw base to perform a dust-collecting hood with a bottom opening to accommodate the saw plate, wherein the saw plate partially emerges out of the bottom opening and is driven by a motor;
a first air-hole defined on a top of the dust-collecting hood over the it bottom opening;
a second air-hole defined on a sidewall of the dust-collecting hood facing the saw plate;
one enclosed sheet formed on the saw base and another enclosed sheets formed on the saw cover correspondingly to narrow the bottom opening to only allow passing the saw plate.

2. The circular saw as claimed in claim 1, wherein the first air-hole is defined on a top edge of the saw base; and
the second air-hole is defined on a sidewall of the saw cover.

3. The circular saw claimed in claim 1, wherein the saw base further has a first interior sidewall facing the saw plate and multiple first retarding sheets formed on the first interior sidewall.

4. The circular saw as claimed in claim 3, wherein the saw cover further has a second interior sidewall and multiple second retarding sheets it formed on the second interior sidewall.
